(19) United States
(12) Patent Application Publication
(10) Pub. No.: US 2006/0219274 A1
(43) Pub. Date: Oct. 5, 2006

(54) Substrate processing apparatus

(75) Inventor: Tomomi Iwata, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/401,668

(22) Filed: Mar. 27, 2006

(30) Foreign Application Priority Data
Mar. 29, 2005 (JP) 2005-095788
Mar. 29, 2005 (JP) 2005-095789
Jan. 18, 2006 (JP) 2006-009832

(51) Int. Cl. B08B 3/10

(52) U.S. Cl. 134/61; 134/82; 134/95.2; 134/902

(57) ABSTRACT

A dry-air supplying duct and a dry-air exhaust duct are opposite each other across a processing tank. Inside the dry-air supplying duct, a plurality of ventilation guides are provided that extend horizontally by a predetermined length from an end of the dry-air supplying duct, and a plurality of ventilation paths are formed by the plurality of ventilation guides. To an end of the dry-air supplying duct, a partition plate is attached such that it blocks a part of the plurality of ventilation paths. Also inside the dry-air supplying duct, a partition plate is attached such that it blocks a part of the plurality of ventilation paths. These partition plates are disposed in upper part of the dry-air supplying duct. As a result, an opening for injection of dry air is formed in a lower part of the dry-air supplying duct.

### BACKGROUND OF THE INVENTION

1. Field of the Invention

The present invention relates to a substrate processing apparatuse that performs various processes on a substrate.

2. Description of the Background Art

Conventionally, substrate processing apparatuses are used for performing various processes on substrates such as semiconductor wafers, glass substrates for photomask, glass substrates for liquid crystal display, glass substrates for plasma display, substrates for optical disc, substrates for magnetic disc, substrates for magneto-optic disc and the like.

One known substrate processing apparatus performs a cleaning process while a plurality of substrates are dipped in a processing tank which stores a processing liquid (see JP 11-354488 A, for example). In this substrate processing apparatus, surfaces of the substrates are subjected to a cleaning process with a chemical solution and pure water in the processing tank. The substrates having subjected to the cleaning process are then drawn up from a position in the processing tank.

If pure water adheres on the substrates after the cleaning process, particles are likely to adhere to the substrates. In addition, the pure water adhered to the substrates will cause formation of water marks on the substrate when naturally dries. For this reason, in the substrate processing apparatus described in JP 11-354488 A, the drying process is performed when the substrates are being drawn up from the position in the processing tank. The drying process is performed in the following manner.

FIG. 13 is given for explaining the drying process of substrates in the substrate processing apparatus disclosed in JP 11-354488 A. As shown in FIG. 13(a), at the end of the cleaning process, a substrate W exists in a processing tank 562 filled with pure water L1.

Then the substrate W starts moving up together with a lifter 563 as shown in FIG. 13(b). As a result, the substrate W is gradually exposed from the pure water L1 to the external atmosphere.

Concurrently with the relative movement between the substrate W and a liquid surface TL1 of the pure water L1, nitrogen gas FG is continuously injected from a nitrogen gas injector 565 to the exposing surface of the substrate W directly above the liquid surface. The nitrogen gas FG is exhausted via a nitrogen gas exhaust duct 568 after traveling directly above the liquid level TL1 of the pure water L1 stored in the processing tank 562.

The nitrogen gas FG injected to the substrate W blows off the pure water L1 adhered to the exposing substrate W. Also, evaporation of the pure water L1 adhered to substrate W is promoted because a gas flow generated by the nitrogen gas FG lowers the humidity of the atmosphere around the liquid surface TL1.

By performing the drying process in the manner as described above, the whole surface of the substrate W will be dried when the substrate W is completely drawn up from the processing tank 562.

FIG. 14 is a perspective view showing a situation in a drying process of substrate by use of the substrate processing apparatus according to JP 11-354488 A. As shown in FIG. 14, each of the plurality of substrates W is drawn up from a position in the pure water L1 while being supported so that its principal plane is substantially parallel with a vertical direction.

FIG. 14 also shows the nitrogen gas injector 565 that supplies a region of the substrate W that is gradually exposing from the position in the pure water L1 with the nitrogen gas FG. As shown in FIG. 14, the nitrogen gas injector 565 has a nitrogen gas supplying tube 565a. The nitrogen gas supplying tube 565a is provided with a plurality of nozzles 565J.

Each of the plurality of nozzles 565J is provided in correspondence with a respective gap between the plurality of substrates W. Nitrogen gas is injected from each of the plurality of nozzles 565J in a substantially horizontal direction. As a result, the nitrogen gas FG is injected to the principal plane of the substrate W. The nitrogen gas FG injected to the substrate W is then exhausted from the nitrogen gas exhaust duct 568.

As already discussed, the gas flow generated by the nitrogen gas FG lowers the humidity of the atmosphere around the liquid surface TL1. In other words, the gas flow generated by the nitrogen gas FG lowers the dew point of the atmosphere around the substrate W. This promotes the evaporation of the pure water L1 adhered to the substrate W.

Therefore, in order to dry the plurality of substrates W uniformly and efficiently, it is preferred to uniform the distribution of dew points in the atmosphere around the substrate W to which the nitrogen gas FG is injected as much as possible.

In the substrate processing apparatus disclosed in JP 11-354488 A, however, the nitrogen gas FG is injected to the plurality of substrates W from the plurality of nozzles 565J. For this reason, it was difficult to uniform the dew point in the atmosphere around the substrate W in the direction which is orthogonal to the principal plane of the substrate W.

In FIG. 14, the dew point greatly differs among positions p1, p2 and p3 lining in the direction which is orthogonal to the principal plane of the substrate W. And also, the dew point greatly differs among positions p2, p4 and p5 lining in the direction which is parallel with the principal plane of the substrate W. For example, the difference in dew point exceeds about 60° C.

When the dew points do not distribute uniformly in the atmosphere around the substrate W as described above, it is difficult to dry the plurality of substrates W uniformly and efficiently.

Also in the substrate processing apparatus disclosed in JP 11-354488 A, since the nitrogen gas FG travels directly above the liquid surface TL1 of the pure water L1 during the drying process, turbulence may occur at the liquid surface TL1. Such turbulence at the liquid surface TL1 may cause inadequate drying of the substrate W.

### SUMMARY OF THE INVENTION

It is an object of the present invention to provide a substrate processing apparatus capable of drying a substrate uniformly and efficiently.

It is another object of the present invention to provide a substrate processing apparatus capable of preventing inadequate drying of a substrate.

(1) A substrate processing apparatus for performing a predetermined process on a substrate according to one aspect of the present invention, comprises a processing tank that stores a processing liquid, a substrate moving up/down device that moves up/down a substrate between a position in a processing liquid stored in the processing tank and a position above the processing tank, and a gas supplying device that supplies gas to a substrate that is being drawn up from the processing tank by the substrate moving up/down device, the gas supplying device including a gas supplying duct disposed on one lateral side of the processing tank, for supplying gas from the one lateral side to the other lateral side of the processing tank along an upper end of the processing tank, and a gas supplying system that supplies gas to the gas supplying duct, the gas supplying duct having a flow-in space into which the gas supplied from the gas supplying system is fed, and a gas flow outlet extending substantially horizontally, for flowing out the gas toward the processing tank, the gas flow outlet being provided such that a cross section of gas flow from the gas supplying duct to the processing tank is smaller than an area from an upper end of the flow-in space to a lower end of the flow-in space in a vertical direction.

In this substrate processing apparatus, the processing tank stores the processing liquid, and the substrate is moved up/down between the position in the processing liquid stored in the processing tank and the position above the processing tank by the substrate moving up/down device. When the substrate is being drawn up from the processing tank by the substrate moving up/down device, the gas is supplied from one lateral side to the other lateral side of the processing tank along the upper end of the processing tank by the gas supplying device disposed on one lateral side of the processing tank. As a result, the processing liquid adhered to the substrate is dries by the gas.

In the gas supplying device, the gas flowing into the flow-in space of the gas supplying duct from the gas supplying system is exhausted through the gas flow outlet. Since the gas flow outlet is arranged such that the cross section of gas flow from the gas supplying duct toward the processing tank is smaller than the region extending from the upper end to the lower end of the flow-in space in the vertical direction, the gas will be blown out strongly through the gas flow outlet along the upper end of the processing tank. As a result, a strong gas flow is generated above the processing tank. Accordingly, the distribution of dew points in the atmosphere around the substrate being drawn up from the processing tank is uniformed directly above the liquid surface of the processing liquid, resulting in the uniformly and efficiently dried substrate.

(2) The gas flow outlet may be provided such that a cross section of a gas flow from the gas supplying duct to the processing tank is limited within a region extending from a position lower than an upper end of the flow-in space to a lower end of the flow-in space.

In this case, since the gas flow outlet is provided such that a cross section of a gas flow from the gas supplying duct to the processing tank is limited within a region extending from a position lower than an upper end of the flow-in space to a lower end of the flow-in space, the gas will be brown out strongly through the gas flow outlet along the upper end of the processing tank. As a result, a strong gas flow is generated above the processing tank. Therefore, the distribution of dew points in the atmosphere around the substrate being drawn up from the processing tank is uniformed directly above the liquid surface of the processing liquid, resulting in the uniformly and efficiently dried substrate.

(3) The gas flow outlet may be formed by providing a blocking part that blocks a region extending from a position lower than an upper end to the upper end of the gas supplying duct on the side of the processing tank.

By providing a blocking part in a region extending from a position lower than an upper end to the upper end of the gas supplying duct on the side of the processing tank, as described above, the cross section of the gas flow from the flow-in space toward the gas flow outlet within the gas supplying duct is limited to a region between the position lower than the upper end of the flow-in space and the lower end of the flow-in space. As a result, uniform and efficient drying of substrate is realized.

(4) The blocking part may have a blocking member provided in an end of the gas supplying duct so as to be movable up and down.

This enables arbitrary adjustment of the speed of gas brown through the gas flow outlet. Therefore, it is possible to adjust the strength of the flow of the gas supplied to the substrate depending on the size of the substrate, size of the processing tank or the like.

(5) The gas flow outlet may be formed in the flow-in space by providing a shielding part that shields a region extending from a position lower than an upper end to the upper end of the flow-in space.

By providing a shielding part in the region extending from the position lower than the upper end of the end of the gas supplying duct to the upper end, as described above, the cross section of the gas flow from the flow-in space toward the gas flow outlet within the gas supplying duct is limited to a region extending from the position lower than the upper end of the flow-in space to the lower end of the flow-in space. As a result, uniform and efficient drying of substrate is realized.

(6) The shielding part may be inclined so that its lower end is closer to the processing tank than its upper end. In this case, the gas is smoothly guided within the gas supplying duct from the flow-in space to the gas flow outlet. As a result, occurrence of turbulence and the like is prevented in the gas supplying duct.

(7) The gas flow outlet may be formed such that a height from an upper end of the processing tank to an upper end of the gas flow outlet in an end of the gas supplying duct is more than 0 cm and not more than 5 cm. In this case, more uniform and efficient drying of substrate is realized.

(8) A width of the gas flow outlet may be more than or equal to a width of the processing tank in the direction orthogonal to the direction in which gas flows on a horizontal plane. In this case, it is possible to dry a plurality of substrates uniformly and efficiently.

(9) The gas supplying device further may include an exhaust duct disposed on the other lateral side of the processing tank, for exhausting an atmosphere above the processing tank. In this case, since the atmosphere above the processing tank is exhausted by the exhausting duct, occurrence of turbulence in the atmosphere above the processing tank is prevented, and a smooth gas flow from one side to the other side of the processing tank is formed. Therefore, more uniform and efficient drying of substrate is realized.

(10) The gas may be dry air. In this case, dry air is supplied to a substrate by the gas supplying device. As a result, the processing liquid adhered to the substrate is replaced by the dry air and removed efficiently.

(11) The processing liquid may be pure water. In this case, since pure water adhered to the substrate is removed by the gas supplied to the substrate, occurrence of a water mark on the surface of the substrate is prevented.

(12) A substrate processing apparatus for performing a predetermined process on a substrate according to another aspect of the present invention comprises a processing tank that stores a processing liquid, a substrate moving up/down device that moves up/down a substrate between a position in a processing liquid in the processing tank and a position above the processing tank, and a gas supplying device that supplies gas to a substrate that is being drawn up from the processing tank by the substrate moving up/down device, the gas supplying device including a lateral gas supplying duct disposed on one lateral side of the processing tank, for supplying gas from the one lateral side to the other lateral side of the processing tank along an upper end of the processing tank, and an upper gas supplying duct disposed above the processing tank, for supplying gas from above toward below of the processing tank.

In this substrate processing apparatus, the processing liquid is stored in the processing tank, and the substrate is moved up/down between the position in the processing liquid stored in the processing tank and the position above the processing tank by the substrate moving up/down device. When the substrate is being drawn up from the processing tank by the substrate moving up/down device, the gas is supplied to the substrate from the one lateral side to the other lateral side of the processing tank along the upper end of the processing tank by the lateral gas supplying duct disposed on the one lateral side of the processing tank, and the gas is supplied to the substrate from above to below the processing tank by the upper gas supplying duct disposed above the processing tank. As a result, the processing liquid adhered to the substrate is dried by the gas.

By providing the gas from side and above to the substrate that is being drawn up from the processing tank, as described above, it is possible to supply the gas having low dew point from the upper gas supplying duct even when the dew point of the gas supplied to the substrate from the lateral gas supplying duct rises. Therefore, the distribution of dew points in the atmosphere above the processing tank can be kept uniform. As a result, it is possible to dry the substrate uniformly and efficiently.

(13) The gas supplying device may further include an exhaust duct disposed on the other lateral side of the processing tank, for exhausting an atmosphere above the processing tank. In this case, since the atmosphere above the processing tank is exhausted by the exhaust duct, occurrence of turbulence in the atmosphere above the processing tank is prevented, and a smooth gas flow from the one side to the other side of the processing tank is formed. Therefore, more uniform and efficient drying of substrate is realized.

(14) The gas may be dry air. In this case, dry air is supplied to the substrate by the gas supplying device. As a result, the processing liquid adhered to the substrate is replaced by the dry air and removed efficiently.

(15) The processing liquid may be pure water. In this case, since the pure water adhered to the substrate is removed by the gas supplied to the substrate, it is possible to prevent a water mark from occurring on the surface of the substrate.

(16) A substrate processing apparatus for performing a predetermined process on a substrate according to still another aspect of the present invention comprises a processing tank that stores a processing liquid; a substrate moving up/down device that moves up/down a substrate between a position in the processing liquid in the processing tank and a position above the processing tank, a gas supplying device that supplies gas from one lateral side to the other lateral side of the processing tank along an upper end of the processing tank to supply gas to the substrate that is being drawn up from the processing tank by the substrate moving up/down device; and a liquid level lowering device that lowers a liquid level of processing liquid stored in the processing tank to below an upper end of the processing tank while gas is supplied to the substrate by the gas supplying device.

In this substrate processing apparatus, the processing tank stores the processing liquid, and the substrate is moved up/down between a position in the processing liquid in the processing tank and the position above the processing tank by the substrate moving up/down device. When the substrate is being drawn up from the processing tank by the substrate moving up/down device, gas is supplied from one lateral side to the other lateral side of the processing tank along the upper end of the processing tank by the gas supplying device. As a result, the gas can be supplied efficiently to the region of the substrate being drawn up from the processing tank.

During supply of the gas to the substrate by the gas supplying device, the liquid level of the processing liquid stored in the processing tank is lowered below the upper end of the processing tank by the liquid level lowering device.

As a result, the gas flow generated by the gas supplied to the substrate is prevented from coming into direct contact with the liquid surface of the processing liquid at the upper end of the processing tank. This prevents occurrence of turbulence caused by the gas flow at the liquid surface of the processing liquid. As a result, it is possible to prevent inadequate drying of the substrate caused by turbulence of the liquid surface of the processing liquid.

(17) An opening may be formed at a position lower than an upper end of a lateral wall of the processing tank, and the liquid level lowering device may have an opening/closing device capable of opening or closing the opening.

In this case, if the processing liquid is continuously supplied to the processing tank while the opening is closed by the opening/closing device, the processing liquid in the processing tank will overflow from the upper end of the processing tank. Therefore, in the condition that the opening is closed by the opening/closing device, the liquid level of the processing liquid can be brought into substantially flush with the upper end of the processing tank.

On the other hand, if the processing liquid is continuously supplied to the processing tank while the opening is opened by the opening/closing device, the processing liquid in the processing tank flows outside through the opening. Therefore, in the condition that the opening is opened by the opening/closing device, the liquid level of the processing liquid may be disposed at a position lower than the upper end of the lateral wall of the processing tank.

(18) The opening may comprise a plurality of through-holes formed to be in line in a horizontal direction. In this case, it is possible to lower the liquid level of the processing liquid while keeping the strength of the lateral wall of the processing tank.

(19) The gas may be dry air. In this case, the dry air is supplied to the substrate by the gas supplying device. As a result, the processing liquid adhered to the substrate is replaced by the dry air and removed efficiently.

(20) The processing liquid may be pure water. In this case, since the pure water adhered to the substrate is removed by the gas supplied to the substrate, it is possible to prevent occurrence of a water mark on the surface of the substrate.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a schematic cross section view showing a structure of a substrate processing apparatus according to a first embodiment;

FIG. 2 is a side elevation illustrating how the substrate processing apparatus according to the first embodiment executes a drying process of substrate;

FIG. 3 is a perspective view illustrating how the substrate processing apparatus according to the first embodiment executes a drying process of substrate;

FIG. 4 is an illustrative view for another structure of the substrate processing apparatus according to the first embodiment;

FIG. 5 is an illustrative view for still another structure of the substrate processing apparatus according to the first embodiment;

FIG. 6 is a schematic cross section view showing a structure of a substrate processing apparatus according to a second embodiment;

FIG. 7 is a side elevation illustrating how the substrate processing apparatus according to the second embodiment executes a drying process of substrate;

FIG. 8 is a schematic cross section view showing a structure of a substrate processing apparatus according to a third embodiment;

FIG. 9 is a schematic cross section view of the substrate processing apparatus along the line J-J in FIG. 8;

FIG. 10 is a schematic cross section view of the substrate processing apparatus along the line K-K in FIG. 9;

FIG. 11 is a view for explaining an operation and a function of a liquid level adjusting shutter during a cleaning process and a drying process in the substrate processing apparatus according to the third embodiment;

FIG. 12 is a view for explaining an operation and a function of a liquid level adjusting shutter during a cleaning process and a drying process in the substrate processing apparatus according to the third embodiment;

FIG. 13 is a view for explaining a drying process of substrate by use of a substrate processing apparatus disclosed in JP 11-354488 A; and

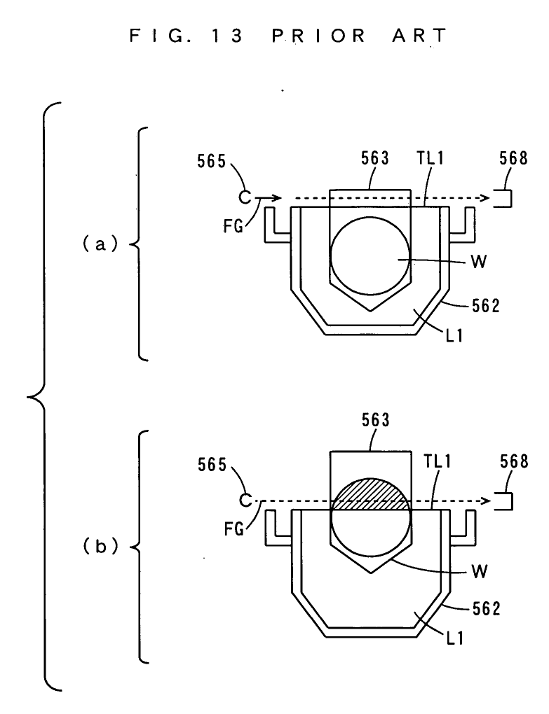

FIG. 14 is a perspective view showing a situation of a drying process of substrate by use of a substrate processing apparatus disclosed in JP 11-354488 A.

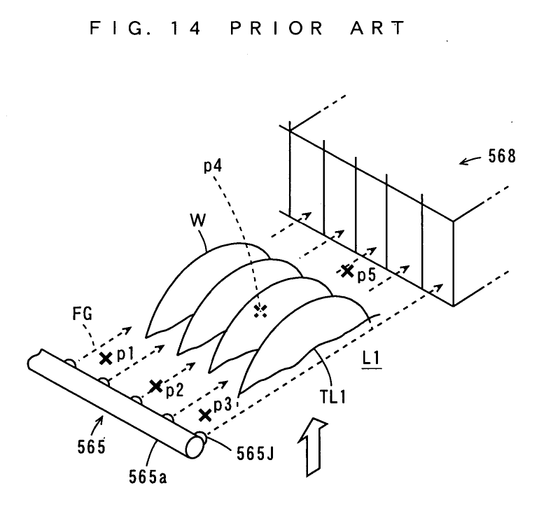

### DESCRIPTION OF THE PREFERRED EMBODIMENTS

Explanation on a substrate processing apparatus according to a first embodiment of the present invention will be made. As used herein, “substrate” refers to semiconductor wafers, glass substrates for photo masking, glass substrates for liquid crystal display, glass substrates for plasma display, substrates for optical disc, substrates for magnetic disc, substrates for magneto-optic disc and the like.

### (1) First Embodiment

(1-a) Structure and Operation of Substrate Processing Apparatus

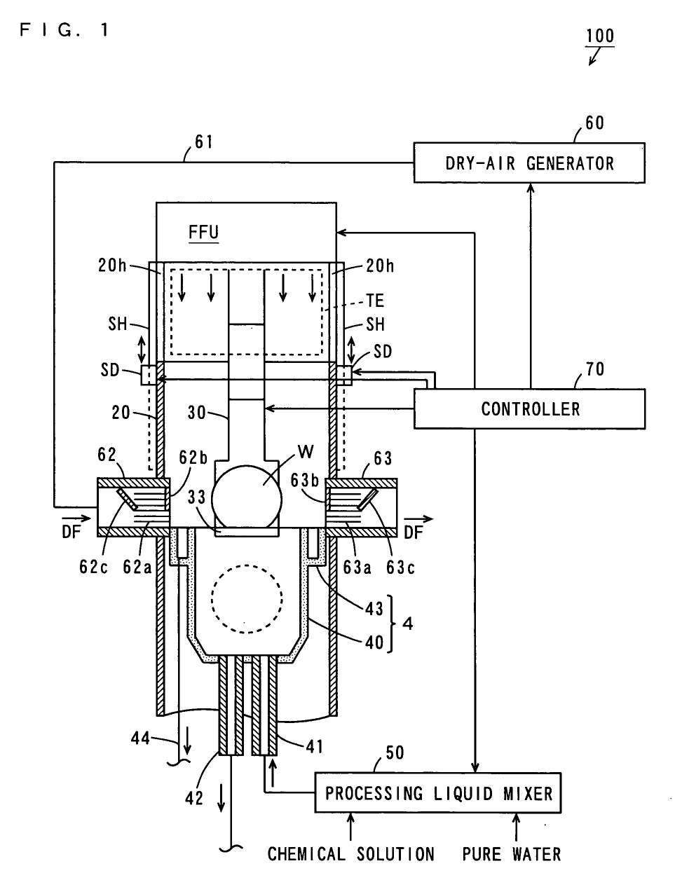

FIG. 1 is a schematic cross section view showing a structure of a substrate processing apparatus according to a first embodiment of the present invention. As shown in FIG. 1, a substrate processing apparatus 100 according to the present embodiment includes a processing tank 4, a downflow duct 20, a substrate shifting mechanism 30, a processing liquid mixer 50, a dry-air generator 60, a controller 70 and a fan filter unit FFU.

The fan filter unit FFU is disposed in an upper part of the downflow duct 20. The fan filter unit FFU has a fan and a filter. As the fan of the fan filter unit FFU operates, a clean descending gas flow (downflow) generates in the downflow duct 20.

The processing tank 4 is disposed in a lower part within the downflow duct 20. The processing tank 4 is made up of an inner tank 40 capable of accommodating a plurality of substrates W, and an outer tank 43 formed so as to surround an upper circumference of the inner tank 40. The inner tank 40 is a generally rectangular parallelepiped.

To a bottom of the inner tank 40 are connected a processing liquid supplying tube 41 for supplying a processing liquid into the inner tank 40 and a processing liquid exhausting tube 42 for exhausting the processing liquid in the inner tank 40. In the present embodiment, a cleaning process for the substrates W is performed in the inner tank 40. The processing liquid that is supplied into the inner tank 40 in the cleaning process is a cleaning solution or a rinsing solution.

To be more specific, surfaces of the substrates W are cleaned by supplying a cleaning solution into the inner tank 40, and dipping the substrates W in the inner tank 40 in which the cleaning solution is stored. Thereafter, the cleaning solution in the inner tank 40 is replaced by the rinsing solution.

Examples of the cleaning solution include BHF (buffered hydrofluoric acid), DHF (dilute hydrofluoric acid), hydrofluoric acid, hydrochloric acid, sulfuric acid, nitric acid, phosphoric acid, acetic acid, oxalic acid, ammonia and the like chemical solutions. Examples of the rinsing solution include pure water, carbonated water, hydrogen water, field ionized water and the like.

In the present embodiment, the processing liquid supplying tube 41 is connected with the processing liquid mixer 50. The processing liquid mixer 50 is supplied with, for example, a chemical solution and pure water. The processing liquid mixer 50 is able to mix the supplied chemical solution and pure water at a given proportion. Thus, the processing liquid mixer 50 supplies such a chemical solution, pure water or mixture thereof, as a processing liquid or a rinsing solution, into the inner tank 40 via the processing liquid supplying tube 41.

To a bottom of the outer tank 43, a processing liquid exhausting tube 44 is connected for exhausting the processing liquid that overflows from the top of the inner tank 40 and flows into the outer tank 43.

Above the inner tank 40, the substrate shifting mechanism 30 is provided. The substrate shifting mechanism 30 vertically shifts a holder 33 that holds the plurality of substrates W.

Above the downflow duct 20, a transfer area TE is provided. The transfer area TE is used when the substrate W is transferred between the holder 33 that holds the substrate W and a transferring mechanism (not illustrated).

In the part of the downflow duct 20 surrounding the transfer area TE, two opposite lateral faces each have an opening 20h. Near each of the two openings 20h, a shutter SH capable of opening/closing the respective opening 20h and a shutter driver SD are provided. The shutter driver SD opens/closes the opening 20h of the downflow duct 20 by driving the shutter SH.

For example, as the shutter SH opens, the transfer mechanism (not illustrated) that holds the substrates W to be subjected to the cleaning process is transferred into the downflow duct 20 and the substrates W are delivered to the to the holder 33. Also, the transfer mechanism (not illustrated) receiving the substrates W having subjected to the cleaning process is fed out of the downflow duct 20 from the interior of the downflow duct 20.

In a part of the downflow duct 20 disposed near the upper end of the processing tank 4, a dry-air supplying duct 62 and a dry-air exhaust duct 63 are respectively attached to two opposite lateral faces.

In the present embodiment, the dry-air supplying duct 62 is provided with a ventilation guide 62a and partition plates 62b, 62c. The dry-air exhaust duct 63 is provided with a ventilation guide 63a and partition plates 63b, 63c. The dry-air supplying duct 62 is connected with the dry-air generator 60 via a piping 61. Details will be described later.

Dry air DF generated by the dry-air generator 60 is fed to the dry-air supplying duct 62 via the piping 61. As a result, the dry air DF is injected to the substrates W that are drawn up from the inner tank 40, whereby a drying process of substrates W is achieved. As the dry air DF is injected to the substrates W, the atmosphere around the substrates W is exhausted via the dry-air exhaust duct 63.

In the present embodiment, the dry air DF is a gas having an extremely low dew point. The dry air DF fed into the downflow duct 20 from the dry-air supplying duct 62 has a dew point of, for example, about −70° C.

As shown in FIG. 1, the controller 70 is connected with the substrate shifting mechanism 30, the processing liquid mixer 50, the dry-air generator 60, the shutter driver SD and the fan filter unit FFU. Controls of down flow in the downflow duct 20, feeding in/out operation of the substrates W relative to the substrate processing apparatus 100, a cleaning process of the substrates W and a drying process of the substrates W are achieved by the controller 70 controlling operations of these elements.

For example, the controller 70 controls the fan filter unit FFU, to cause generation of a downflow in the downflow duct 20.

The controller 70 controls the substrate shifting mechanism 30 to make the holder 33 holding the substrates W move into the inner tank 40 at the beginning of the cleaning process. In this state, the controller 70 controls the processing liquid mixer 50 to supply as a cleaning solution, a chemical solution or a mixture of a chemical solution and pure water into the inner tank 40. As a result, the substrates W are dipped into the cleaning solution in the inner tank 40, and surfaces of the substrates W are cleaned.

Thereafter, the controller 70 controls the processing liquid mixer 50 to supply pure water as a rinsing solution into the inner tank 40 for replacing the cleaning solution in the inner tank 40 with pure water. As a result, the substrates W are dipped into the pure water within the inner tank 40. This completes the cleaning process of the substrates W.

The controller 70 controls the substrate shifting mechanism 30 to draw up the substrates W having experienced the cleaning process above the inner tank 40 where the controller 70 controls the dry-air generator 60 to supply dry air DF to the substrates W that are being drawn up. As a result, the pure water adhered to the substrates W is replaced by the dry air DF, so that surfaces of the substrates W are dried (drying process).

At times other than the drying process, the controller 70 controls the dry-air generator 60, thereby reducing the supply amount of the dry air DF into the downflow duct 20 (slow leak).

At the time of drawing up the substrates W from the inner tank 40, the controller 70 controls the processing liquid mixer 50 to continuously supply a small amount of water into the inner tank 40. Accordingly, when the substrates W are drawn up from the inner tank 40, pure water overflows from the upper opening of the inner tank 40. The pure water overflowing from the inner tank 40 flows into the outer tank 43, and is exhausted via the processing liquid exhausting tube 44 connected to the outer tank 43.

Each of the processing liquid supplying tube 41 and the processing liquid exhausting tubes 42, 44 has a valve (not illustrated). The controller 70 also controls opening/closing operations of these valves. In this way, opening/closing operations of the supplying and exhausting systems of the processing liquid in the processing tank 4 are controlled by the controller 70.

(1-b) Details of Structure and Drying Process of Substrate Processing Apparatus

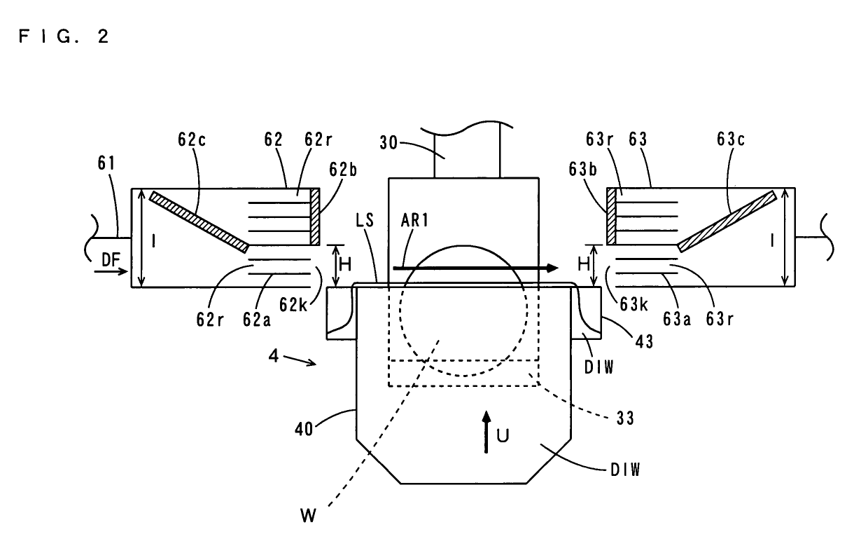

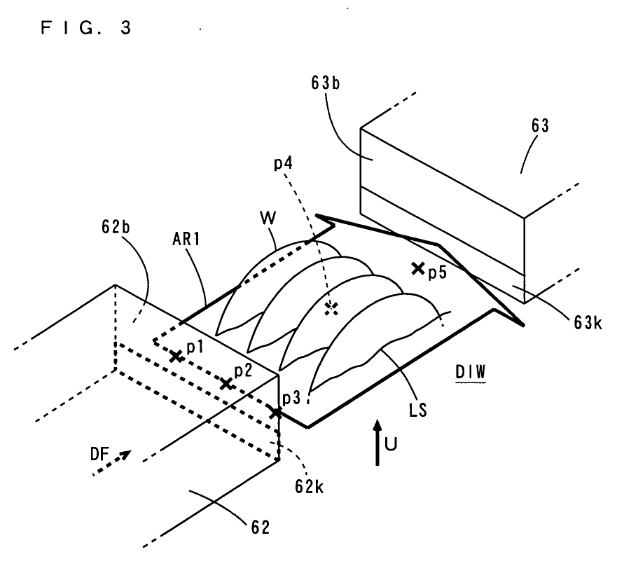

FIG. 2 is a side elevation illustrating how the substrate processing apparatus 100 according to the first embodiment executes a drying process of substrates W, and FIG. 3 is a perspective view illustrating how the substrate processing apparatus 100 according to the first embodiment executes a drying process of substrates W. During the drying process of substrates W, the holder 33 holding a plurality of substrates W is gradually drawn up from the processing tank 4 by the substrate shifting mechanism 30 as denoted by the arrow U.

As shown in FIG. 2 and FIG. 3, the dry-air supplying duct 62 and the dry-air exhaust duct 63 are provided so as to be opposite each other on the plane along the upper end of the processing tank 4 while the processing tank 4 is interposed therebetween. The dry-air supplying duct 62 and the dry-air exhaust duct 63 both have a boxy shape.

Further, in the direction that is orthogonal to the direction in which the dry-air supplying duct 62 and the dry-air exhaust duct 63 are opposite each other, the lengths (widths) of the dry-air supplying duct 62 and the dry-air exhaust duct 63 are set to be larger than the length (width) of the inner tank 40 of the processing tank 4.

As shown in FIG. 2, inside the dry-air supplying duct 62, there are provided a plurality of ventilation guides 62a of a predetermined length extending horizontally from an end of the dry-air supplying duct 62. The plurality of ventilation guides 62a form a plurality of ventilation paths 62r.

On an end of the dry-air supplying duct 62 disposed on the side of the processing tank 4, the partition plate 62b is attached such that it block off a part of the plurality of ventilation paths 62r. Also inside the dry-air supplying duct 62, the partition plate 62c is attached such that it blocks off a part of the plurality of ventilation paths 62r. The partition plate 62c is inclined such that its lower end is closer to the processing tank 4 than its upper end so that the dry air DF supplied from the piping 61 may smoothly flow to the other ventilation path 62r.

The partition plates 62b, 62c both are disposed in an upper part of the dry-air supplying duct 62. Accordingly, a dry-air injecting opening 62k is formed in a lower part of the dry-air supplying duct 62.

The dry-air exhaust duct 63 is provided with a plurality of ventilation guides 63a as is the case with the dry-air supplying duct 62. As a result, a plurality of ventilation paths 63r are formed.

Further, on an end of the dry-air exhaust duct 63 disposed on the side of the processing tank 4 and inside the dry-air exhaust duct 63, the partition plates 63b, 63c are attached as is the case of the dry-air supplying duct 62. Accordingly, below dry-air exhaust duct 63, an exhausting opening 63k is formed.

Here, a distance H in the vertical direction between the upper end of the processing tank 4 (inner tank 40 and outer tank 43) and the upper end of the dry-air injecting opening 62k, as well as a distance H between the upper end of the processing tank 4 and the upper of the exhausting opening 63k are set to be smaller than the heights I of interior in the vertical direction of the dry-air supplying duct 62 and the dry-air exhaust duct 63.

For example, when the height I is set to be 10 cm, the distance H is preferably set to be larger than 0 cm and smaller than or equal to 5 cm.

Preferably, the distance in the vertical direction between the upper end of the processing tank 4 and the lower end of the dry-air injecting opening 62k, as well as the distance between the upper end of the processing tank 4 and the lower end of the exhausting opening 63k are set to be very small. In particular, the positional relationship in the vertical direction between the upper end of the processing tank 4 and the lower end of the dry-air injecting opening 62k is more preferably set to be appropriately the same with the positional relationship between the upper end of the processing tank 4 and the lower end of the exhausting opening 63k.

As described above, by providing the ventilation guide 62a and attaching the partition plates 62b, 62c in the dry-air supplying duct 62, the dry air DF supplied into the dry-air supplying duct 62 through the piping 61 is narrowed down by the partition plates 62b, 62c, and then injected via the dry-air injecting opening 62k.

Therefore, the pressure of the dry air DF injected from the dry-air injecting opening 62k is larger than that of the dry air DF supplied into the dry-air supplying duct 62 through the piping 61.

Accordingly, as denoted by the arrow AR1, the dry air DF is strongly injected via the whole dry-air injecting opening 62k that is horizontally formed directly above the liquid level LS of pure water DIW stored in the processing tank 4. As a result, a gas flow is generated above the liquid surface LS of the pure water DIW. Therefore, distribution of dew points in the atmosphere around the substrates W that are being drawn up from a position in the pure water DIW is uniformed directly above the liquid surface LS of the pure water DIW, making it possible to dry the plurality of substrates W uniformly and efficiently.

Furthermore, in the dry-air exhaust duct 63, since the distance H between the upper end of the processing tank 4 and the upper end of the exhausting opening 63k is set to be smaller than the inner height I of the dry-air exhaust duct 63 in the vertical direction, the gas flow generated by injection of the dry air DF is prevented from diffusing near the dry-air exhaust duct 63 above the processing tank 4, so that smooth flow traveling from one side to the other side of the processing tank 4 is formed.

In this case, distribution of dew points in the atmosphere around the substrates W that are being drawn up from the position in the pure water DIW is further uniformed directly above the liquid surface LS of the pure water DIW. And by the dry air DF strongly injected directly above the liquid surface LS of the pure water DIW, the pure water DIW that adheres to the substrates W that are being gradually drawn up from the position in the pure water DIW is replaced more efficiently and removed from the surfaces of the substrates W. This makes it possible to dry the plurality of substrates W more uniformly and efficiently.

Furthermore, as described above, in the present embodiment, widths (dry-air injecting opening 62k and exhausting opening 63k) of the dry-air supplying duct 62 and the dry-air exhaust duct 63 are set to be larger than the width of the inner tank 40 of the processing tank 4 in the direction that is orthogonal to the direction in which the dry-air supplying duct 62 and the dry-air exhaust duct 63 are opposite each other (the direction orthogonal to planes of the substrates W).

As a result, the area in which a gas flow generated between the dry-air supplying duct 62 and the dry-air exhaust duct 63 is formed covers the inner tank 40, making it possible to dry the plurality of substrates W more uniformly and efficiently.

As described above, when the inner heights I of the dry-air supplying duct 62 and the dry-air exhaust duct 63 in the vertical direction are set to be 10 cm, preferably, the height H in the vertical direction between the upper end of the processing tank 4 and the upper end of the dry-air injecting opening 62k, as well as the height H between the upper end of the processing tank 4 and the upper end of the exhausting opening 63k are set to be larger than 0 cm and not more than 5 cm. This makes it possible to dry the plurality of substrates W more uniformly and efficiently.

In the present embodiment, the partition plate 62c is inclined such that its lower end is closer to the processing tank 4 than the upper end so that dry air DF supplied from the piping 61 may smoothly flow to the other ventilation path 62r. As a result, occurrence of turbulence within the dry-air supplying duct 62 is prevented. Accordingly, the dry air DF is injected smoothly via the dry-air injecting opening 62k.

In the present embodiment, the partition plates 62b, 62c, 63b, 63c attached to the dry-air supplying duct 62a and the dry-air exhaust duct 63 may be attached in a vertically movable manner.

In such a case, each of the dry-air supplying duct 62 and the dry-air exhaust duct 63 is provided with a partition plate driver for vertically moving the partition plates 62b, 62c, 63b, 63c, and the partition plate driver is controlled by the controller 70. This makes the sizes of the dry-air injecting opening 62k and the exhausting opening 63k (height in the vertical direction) variable.

By varying the sizes of the dry-air injecting opening 62k and the exhausting opening 63k, it is possible to adjust the speed of the gas flow generated directly above the liquid surface LS of the pure water DIW depending on the size of the processing tank 4, size of the substrate W and the like.

As is shown in the above structure, in the substrate processing apparatus 100 according to the present embodiment, the dry-air supplying duct 62 and the dry-air exhaust duct 63 are attached with the partition plates 62b, 62c, 63b, 63c for restricting openings thereof. Accordingly, even for an existent substrate processing apparatus, it is possible to adjust distribution of dew points in the atmosphere around the substrates W more easily by attaching the partition plates to the ducts.

In the present embodiment, the drying process is performed by supplying the substrate W with the dry air DF, and the gas supplied to the substrate W is not limited to the dry air DF. Alternative to the dry air DF, for example, IPA (isopropyl alcohol) steam may be used, or low-temperature N₂ (nitrogen) gas may be used.

### (1-c) EXAMPLES

Inventors investigates distribution of dew points in the atmosphere around the substrates W when dry air DF is injected directly above the liquid surface LS of the pure water DIW in the substrate processing apparatus 100 having the foregoing structure.

In the substrate processing apparatus 100 according to an example, the inner height I in the vertical direction of the dry-air supplying duct 62 and the dry-air exhaust duct 63 was 10 cm. The distance H in the vertical direction between the upper end of the processing tank 4 and the upper end of the dry-air injecting opening 62k, and the distance H between the upper end of the processing tank 4 and the upper end of the exhausting opening 63k were 4 cm.

Further, the vertical positional relationship between the upper end of the processing tank 4 and the lower end of the dry air injecting opening 62k was as same as the positional relationship between the upper end of the processing tank 4 and the lower end of the exhausting opening 63k.

The speed of gas flow when the dry air DF is injected from the dry-air injecting opening 62k was set at about 8 m/s, and the dew point of the dry air DF at the dry-air injecting opening 62k was set to about −70° C.

In this state, the inventor of the present invention examined dew pointes at positions p1, p2, p3 around the dry-air injecting opening 62k lining in the direction orthogonal to planes of the substrates W while injecting dry air DF directly above the liquid surface LS of the pure water DIW (atmosphere around the substrates W).

Also the inventor of the present invention examined dew points at positions p2, p4, p5 lining at regular intervals in the direction that is parallel with planes of the substrates W between the dry-air supplying duct 62 and the dry-air exhaust duct 63.

Dew points at the positions p1, p2, p3 were −67.4° C., −67.3° C. and −67.3° C., respectively. Further, dew points at the positions p2, p4, p5 were −67.3° C., −56.7° C. and −42.8° C., respectively.

These result revealed that distribution of dew points in the atmosphere around the substrates W, or in the atmosphere directly above the liquid surface LS of the pure water DIW is limited within about 25° C.

Thus, it was demonstrated that a plurality of substrates W can be dried uniformly and efficiently by making the distribution of dew points in the atmosphere around the substrates W that are being drawn up from the position in the pure water DIW, generally uniform directly above the liquid surface LS of the pure water DIW in the manner as described above.

(1-d) Other Exemplary Structures of Substrate Processing Apparatus According to First Embodiment

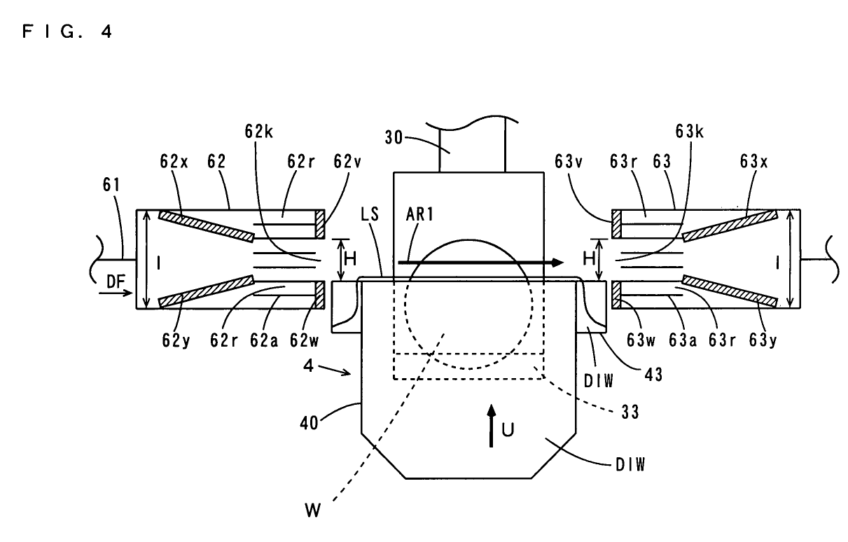

Not limited to the above exemplary structure, the substrate processing apparatus 100 according to the first embodiment may have a structure as will be described now. FIG. 4 is a view for explaining other structure of the substrate processing apparatus 100 according to the first embodiment. In the followings, explanation will be made on the points for the present example of the substrate processing apparatus 100 that are different from those of the substrate processing apparatus 100 shown in FIG. 1.

Likewise FIG. 2, FIG. 4 illustrates a drying process of the substrates W by a side elevation. As shown in FIG. 4, in the present example of the substrate processing apparatus 100, the positions in the height direction of the dry-air supplying duct 62 and the dry-air exhaust duct 63 are different from the positions of the dry-air supplying duct 62 and the dry-air exhaust duct 63 in the substrate processing apparatus 100 shown in FIGS. 1 to 3.

To be more specific, in the present example, the lower ends of the dry-air supplying duct 62 and the dry-air exhaust duct 63 are disposed at slightly lower positions than the upper end of the processing tank 4.

The dry-air supplying duct 62 has in its end disposed on the side of the processing tank 4, two partition plates 62v, 62w attached so as to block a part of the ventilation paths 62r. Also in the dry-air supplying duct 62, two partition plates 62x, 62y are attached so as to block a part of the plurality of ventilation paths 62r.

Here, both of the partition plates 62v, 62x are disposed in an upper part of the dry-air supplying duct 62, while both of the partition plates 62w, 62y are disposed in a lower part of the dry-air supplying duct 62.

The partition plate 62x is inclined such that its lower end is closer to the processing tank 4 than its upper end so that the dry air DF supplied from the piping 61 may smoothly flow to the other ventilation path 62r.

On the other hand, the partition plate 62y is inclined such that its upper end comes closer to the processing tank 4 than its lower end so that the dry air DF supplied from the piping 61 may smoothly flow into the other ventilation path 62r.

As described above, by providing the dry-air supplying duct 62 with the plurality of partition plates 62v, 62w, 62x, 62y, the dry-air injecting opening 62k is formed in approximately center of the dry-air supplying duct 62 in the vertical direction.

Also an end of the dry-air exhaust duct 63 disposed on the side of the processing tank 4 and the interior of the dry-air exhaust duct 63 are formed with a plurality of partition plates 63v, 63w, 63x, 63y as is the case with the dry-air supplying duct 62. As a result, an exhausting opening 63k is formed in an approximately center of the dry-air exhaust duct 63 in the vertical direction.

Also in the present example, the distance H in the vertical direction between the upper end of the processing tank 4 (inner tank 40 and outer tank 43) and the upper end of the dry-air injecting opening 62k, and the distance H between the upper end of the processing tank 4 and the upper end of the exhausting opening 63k are set to be smaller than the inner heights I in the vertical direction of the dry-air supplying duct 62 and the dry-air exhaust duct 63.

Preferably, the distance in the vertical direction between the upper end of the processing tank 4 and the lower end of the dry-air injecting opening 62k, and the distance between the upper end of the processing tank 4 and the lower end of the exhausting opening 63k are set to be as small as possible.

In particular, it is more preferable to set the positional relationship in the vertical direction between the upper end of the processing tank 4 and the lower end of the dry-air injecting opening 62k to be appropriately the same with the positional relationship between the upper end of the processing tank 4 and the lower end of the exhausting opening 63k. For example, the partition plates 62w, 62y are arranged so that their upper ends are disposed on the plane along the upper end of the processing tank 4. Further, the partition plates 63w, 63y are arranged so that their upper ends are disposed on the plane along the processing tank 4.

As describe above, by providing the ventilation guides 62a and attaching the partition plates 62v, 62w, 62x, 62y in the dry-air supplying duct 62, the dry air DF supplied into the dry-air supplying duct 62 via the piping 61 is narrowed down by the partition plates 62v, 62w, 62x, 62y and injected through the dry-air injecting opening 62k. The injected dry air DF is exhausted through the exhausting opening 63k of the dry-air exhaust duct 63.

Also in this example, when the inner height I in the vertical direction of the dry-air supplying duct 62 and the dry-air exhaust duct 63 is set to be 10 cm, the distance H in the vertical direction between the upper end of the processing tank 4 and the upper end of the dry-air injecting opening 62k, as well as the distance H between the upper end of the processing tank 4 and the upper end of the exhausting opening 63k is set to be larger than 0 cm and not more than 5 cm. In this case, it is possible to dry the plurality of substrates W more uniformly and efficiently.

(1-e) Still Another Exemplary Structure of the Substrate Processing Apparatus According to the First Embodiment

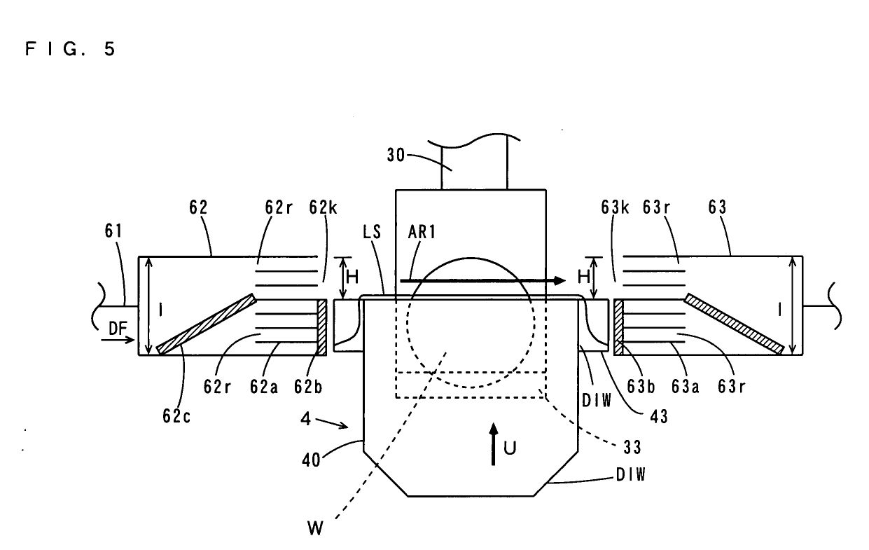

Not limited to the above exemplary structure, the substrate processing apparatus 100 according to the first embodiment may have a structure as will be described below. FIG. 5 is a view for explaining still another structure of the substrate processing apparatus 100 according to the first embodiment. In the followings, explanation will be made on the points for the present example of the substrate processing apparatus 100 that are different from those of the substrate processing apparatus 100 shown in FIG. 1.

Likewise FIG. 2, FIG. 5 illustrates a drying process of the substrates W by a side elevation. As shown in FIG. 5, in the present example of the substrate processing apparatus 100, the positions in the height direction of the dry-air supplying duct 62 and the dry-air exhaust duct 63 are different from the positions of the dry-air supplying duct 62 and the dry-air exhaust duct 63 in the substrate processing apparatus 100 shown in FIGS. 1 to 3.

To be more specific, in the present example, the lower ends of the dry-air supplying duct 62 and the dry-air exhaust duct 63 are disposed in a lower part of the upper end of the processing tank 4, and the approximate center in the vertical direction of the dry-air supplying duct 62 and the dry-air exhaust duct 63 is disposed on the plane along the upper end of the processing tank 4.

The dry-air supplying duct 62 has in its end disposed on the side of the processing tank 4, the partition plate 62b attached so as to block a part of the plurality of ventilation paths 62r. Also in the dry-air supplying duct 62, the partition plate 62c is attached so as to block a part of the plurality of ventilation path 62r. The partition plate 62c is inclined such that its upper end comes closer to the processing tank 4 than its lower end so that the dry air DF supplied from the piping 61 may smoothly flow into the other ventilation path 62r.

Both of the partition plates 62b, 62c are disposed in a lower part of the dry-air supplying duct 62. As a result, the dry air injecting opening 62k is formed in an upper part of the dry-air supplying duct 62.

Also an end of the dry-air exhaust duct 63 disposed on the side of the processing tank 4 and the interior of the dry-air exhaust duct 63 are attached with partition plates 63b, 63c as is the case with the dry-air supplying duct 62. As a result, an exhausting opening 63k is formed above the dry-air exhaust duct 63.

Also in the present example, the distance H in the vertical direction between the upper end of the processing tank 4 (inner tank 40 and outer tank 43) and the upper end of the dry-air injecting opening 62k, and the distance H between the upper end of the processing tank 4 and the upper end of the exhausting opening 63k are set to be smaller than the inner heights I in the vertical direction of the dry-air supplying duct 62 and the dry-air exhaust duct 63.

Preferably, the distance in the vertical direction between the upper end of the processing tank 4 and the lower end of the dry-air injecting opening 62k, and the distance between the upper end of the processing tank 4 and the lower end of the exhausting opening 63k are set to be as small as possible.

In particular, it is more preferable to set the positional relationship in the vertical direction between the upper end of the processing tank 4 and the lower end of the dry-air injecting opening 62k to be appropriately the same with the positional relationship between the upper end of the processing tank 4 and the lower end of the exhausting opening 63k. For example, the partition plates 62b, 63b are arranged so that their upper ends are disposed on the plane along the upper end of the processing tank 4.

As describe above, by providing the ventilation guides 62a and attaching the partition plates 62b, 62c in the dry-air supplying duct 62, the dry air DF supplied into the dry-air supplying duct 62 via the piping 61 is narrowed down by the partition plates 62b, 62c and injected through the dry-air injecting opening 62k. The injected dry air DF is exhausted through the exhausting opening 63k of the dry-air exhaust duct 63.

Also in this example, when the inner height I in the vertical direction of the dry-air supplying duct 62 and the dry-air exhaust duct 63 is set to be 10 cm, the distance H in the vertical direction between the upper end of the processing tank 4 and the upper end of the dry-air injecting opening 62k, as well as the distance H between the upper end of the processing tank 4 and the upper end of the exhausting opening 63k is set to be larger than 0 cm and not more than 5 cm. In this case, it is possible to dry the plurality of substrates W more uniformly and efficiently.

### (2) Second Embodiment

(2-a) Structure and Operation of Substrate Processing Apparatus According to Second Embodiment

A substrate processing apparatus according to the second embodiment differs in the following points in structure and operation from the substrate processing apparatus 100 according to the first embodiment.

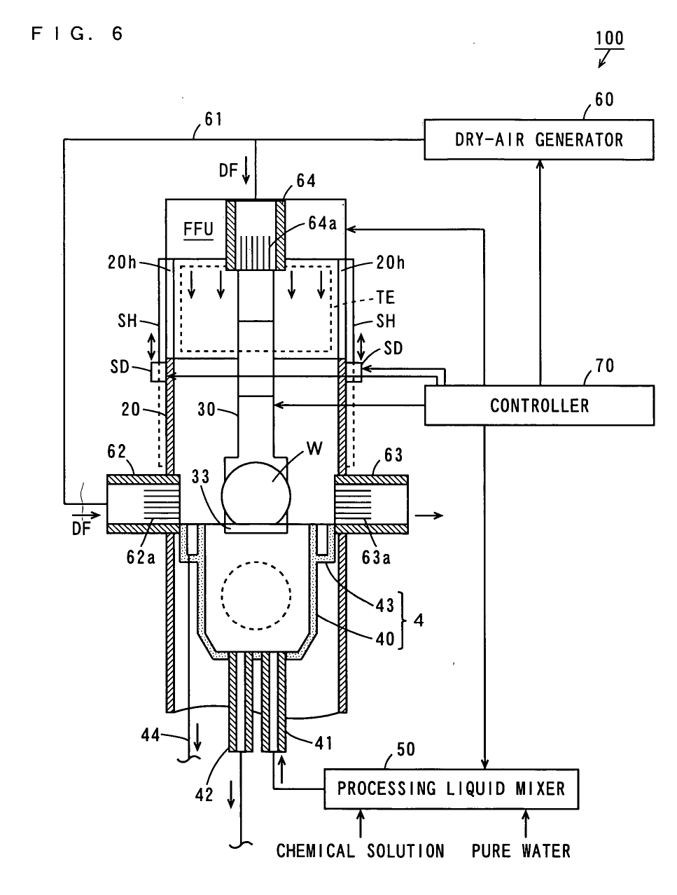

FIG. 6 is a schematic cross-section view showing a structure of a substrate processing apparatus according to the second embodiment. As shown in FIG. 6, the substrate processing apparatus 100 according to the present embodiment has a dry-air supplying duct 64 provided above the downflow duct 20 in addition to the structure of the substrate processing apparatus 100 according to the first embodiment.

Further, the partition plates 62b, 62c, 63b, 63c described in the first embodiment are not attached to the dry-air supplying duct 62 and the dry-air exhaust duct 63. In the dry-air supplying duct 64, ventilation guides 64a is provided as is the case with the dry-air supplying duct 62 and the dry-air exhaust duct 63.

The dry-air supplying duct 64 is connected with the dry-air generator 60 via the piping 61 as is the case with the dry-air supplying duct 62. Accordingly, the dry air DF supplied from the dry-air generator 60 to the piping 61 is also supplied to the dry-air supplying duct 64 as well as to the dry-air supplying duct 62.

Therefore, during the drying process of the substrates W, the dry air DF is injected from the lateral side and from above toward the substrates W that are being drawn up from the position in the pure water DIW in the processing tank 4.

(2-b) Details of Structure of Substrate Processing Apparatus and Drying Process

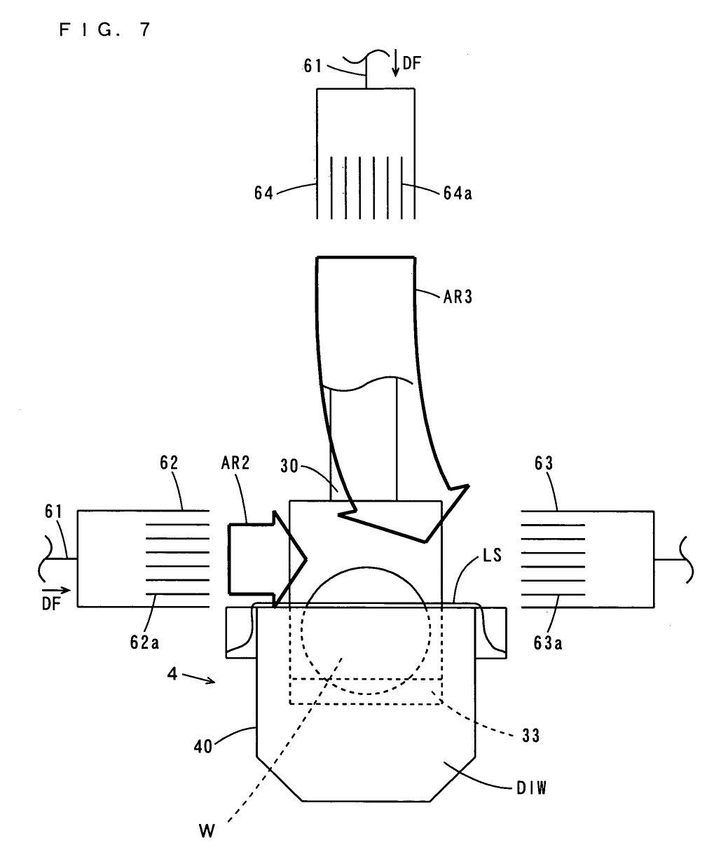

FIG. 7 is a side elevation illustrating how the substrate processing apparatus 100 according to the second embodiment executes a drying process of substrate W.

As shown in FIG. 7, in the substrate processing apparatus 100 according to the present embodiment, at the time of drying process of the substrates W, the dry air DF is injected to the substrates W from the dry-air supplying duct 62 disposed laterally of the processing tank 4. As a result, as shown by the arrow AR2, a horizontal gas flow is generated that flows from the dry-air supplying duct 62 to the dry-air exhaust duct 63 after passing directly above the liquid surface LS of the pure water DIW.

Also in a drying process of the substrates W, the dry air DF is injected to the substrates W from the dry-air supplying duct 64 disposed above the processing tank 4. As a result, as shown by the arrow AR3, a gas flow is generated that flows from above the liquid surface LS of the pure water DIW to the dry-air exhaust duct 63 disposed laterally of the processing tank 4.

The dry air DF injected from the dry-air supplying duct 62 replaces for the pure water DIW adhered to the substrates W and the pure water DIW stored in the processing tank 4. Accordingly, if the dry-air supplying duct 64 is not provided, the atmosphere around the dry-air exhaust duct 63 will have a higher dew point than the atmosphere around the dry-air supplying duct 62.

In the present embodiment, however, an additional dry-air supplying duct 64 is provided above the processing tank 4. This enables fresh dry air DF to be supplied to the atmosphere around the dry-air supplying duct 62 during drying process of the substrates W. Therefore, the dew point in the area around the dry-air exhaust duct 63 is prevented from rising by the dry air DF injected from the dry-air supplying duct 64. Thus distribution of dew points between the dry-air supplying duct 62 and the dry-air exhaust duct 63 is kept substantially uniform. As a result, it is possible to dry the plurality of the substrates W uniformly and efficiently.

In the present embodiment, by providing the dry-air exhaust duct 63, a smooth flow of dry air DF flowing one side to the other side of the processing tank 4 is formed. This enables the plurality of substrates W to be dried uniformly and efficiently.

Also in the present embodiment, the drying process is performed by supplying the substrates W with dry air DF, and the gas supplied to the substrates W is not limited to the dry air DF. For example, IPA (isopropyl alcohol) steam, or low-temperature N₂ (nitrogen) gas may be used instead of the dry air DF.

### (3) Third Embodiment

(3-a) Structure and Operation of Substrate Processing Apparatus

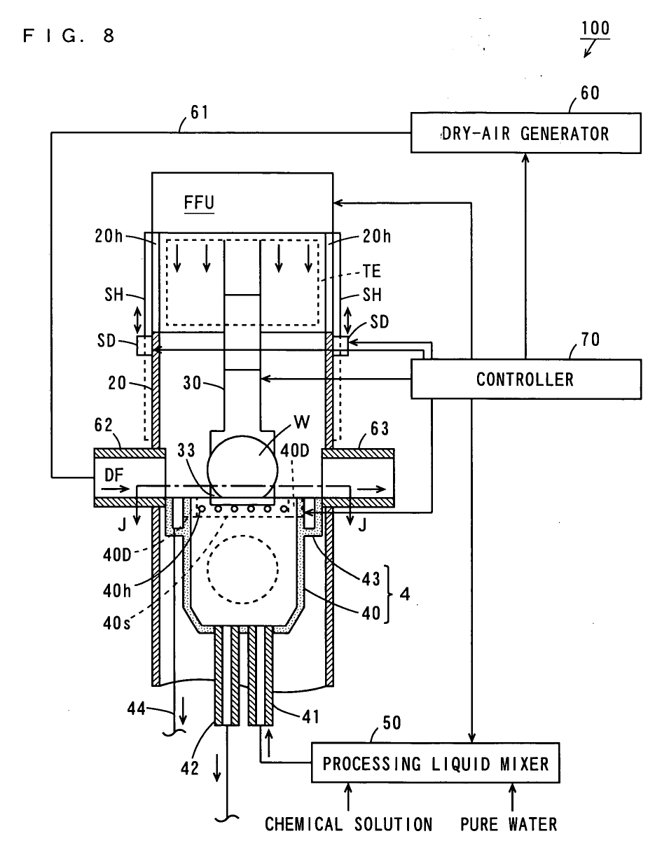

FIG. 8 is a schematic cross section view showing a structure of a substrate processing apparatus according to the third embodiment. As shown in FIG. 8, a substrate processing apparatus 100 according to the present embodiment has a processing tank 4, a downflow duct 20, a substrate shifting mechanism 30, a processing liquid mixer 50, a dry-air generator 60, a controller 70 and a fan filter unit FFU.

Above the downflow duct 20, the fan filter unit FFU is disposed. The fan filter unit FFU has a fan and a filter. As the fan of the fan filter unit FFU operates, a clean descending gas flow (downflow) is generated in the downflow duct 20.

The processing tank 4 is disposed in a lower part within the downflow duct 20. The processing tank 4 is made up of an inner tank 40 capable of accommodating a plurality of substrates W, and an outer tank 43 formed so as to surround an upper circumference of the inner tank 40. The inner tank 40 is substantially a generally rectangular parallelepiped.

To a bottom of the inner tank 40 are connected a processing liquid supplying tube 41 for supplying a processing liquid into the inner tank 40 and a processing liquid exhausting tube 42 for exhausting the processing liquid in the inner tank 40. In the present embodiment, a cleaning process for the substrates W is performed in the inner tank 40. The processing liquid that is supplied into the inner tank 40 in the cleaning process is a cleaning solution or a rinsing solution.

To be more specific, surfaces of the substrates W are cleaned by supplying a cleaning solution into the inner tank 40, and dipping the substrates W in the inner tank 40 in which the cleaning solution is stored. Thereafter, the cleaning solution in the inner tank 40 is replaced by the rinsing solution.

Examples of the cleaning solution include BHF (buffered hydrofluoric acid), DHF (dilute hydrofluoric acid), hydrofluoric acid, hydrochloric acid, sulfuric acid, nitric acid, phosphoric acid, acetic acid, oxalic acid, ammonia and the like chemical solutions. Examples of the rinsing solution include pure water, carbonated water, hydrogen water, field ionized water and the like.

In the present embodiment, the processing liquid supplying tube 41 is connected with the processing liquid mixer 50. The processing liquid mixer 50 is supplied with, for example, a chemical solution and pure water. The processing liquid mixer 50 is able to mix the supplied chemical solution and pure water at a given proportion. Thus, the processing liquid mixer 50 supplies such a chemical solution, pure water or mixture thereof, as a processing liquid or a rinsing solution, into the inner tank 40 via the processing liquid supplying tube 41.

To a bottom of the outer tank 43, a processing liquid exhausting tube 44 is connected for exhausting the processing liquid that overflows from the top of the inner tank 40 and flows into the outer tank 43.

In the present embodiment, a plurality of through-holes 40h are formed in an upper part of a lateral wall of the inner tank 40. Additionally, in the lateral wall of the inner tank 40, a liquid level adjusting shutter 40s opening/closing the plurality of through-holes 40h and a shutter driver 40D are provided near the plurality of through-holes 40h. Details will be described later.

Above the inner tank 40, the substrate shifting mechanism 30 is provided. The substrate shifting mechanism 30 vertically shifts a holder 33 that holds the plurality of substrates W.

Above the downflow duct 20, a transfer area TE is provided. The transfer area TE is used when the substrate W is transferred between the holder 33 that holds the substrate W and a transferring mechanism (not illustrated).

In the part of the downflow duct 20 surrounding the transfer area TE, two opposite lateral faces each have an opening 20h. Near each of the two openings 20h, a shutter SH capable of opening/closing the respective opening 20h and a shutter driver SD are provided. The shutter driver SD opens/closes the opening 20h of the downflow duct 20 by driving the shutter SH.

For example, as the shutter SH opens, the transfer mechanism (not illustrated) that holds the substrates W to be subjected to the cleaning process is transferred into the downflow duct 20 and the substrates W are delivered to the to the holder 33. Also, the transfer mechanism (not illustrated) receiving the substrates W having subjected to the cleaning process is fed out of the downflow duct 20 from the interior of the downflow duct 20.

In a part of the downflow duct 20 disposed near the upper end of the processing tank 4, a dry-air supplying duct 62 and a dry-air exhaust duct 63 are respectively attached to two opposite lateral faces. The dry-air supplying duct 62 is connected with the dry-air generator 60 via a piping 61.

Dry air DF generated by the dry-air generator 60 is fed to the dry-air supplying duct 62 via the piping 61. As a result, the dry air DF is injected to the substrates W that are being drawn up from the inner tank 40, whereby a drying process of substrates W is achieved. As the dry air DF is injected to the substrates W, the atmosphere around the substrates W is exhausted via the dry-air exhaust duct 63.

In the present embodiment, the dry air DF is a gas having an extremely low dew point. The dry air DF fed into the downflow duct 20 from the dry-air supplying duct 62 has a dew point of, for example, about −70° C.

As shown in FIG. 8, the controller 70 is connected with the substrate shifting mechanism 30, the processing liquid mixer 50, the dry-air generator 60, the shutter drivers 40D, SD and the fan filter unit FFU. Controls of down flow in the downflow duct 20, feeding in/out operation of the substrates W relative to the substrate processing apparatus 100, a cleaning process of the substrates W and a drying process of the substrates W are achieved by the controller 70 controlling operations of these elements.

For example, the controller 70 controls the fan filter unit FFU, to cause generation of a downflow in the downflow duct 20.

The controller 70 controls the substrate shifting mechanism 30 to make the holder 33 holding the substrates W move into the inner tank 40 at the beginning of the cleaning process. In this state, the controller 70 controls the processing liquid mixer 50 to supply as a cleaning solution, a chemical solution or a mixture of a chemical solution and pure water into the inner tank 40. As a result, the substrates W are dipped into the cleaning solution in the inner tank 40, and surfaces of the substrates W are cleaned.

Thereafter, the controller 70 controls the processing liquid mixer 50 to supply pure water as a rinsing solution into the inner tank 40 for replacing the cleaning solution in the inner tank 40 with pure water. As a result, the substrates W are dipped into the pure water within the inner tank 40. This completes the cleaning process of the substrates W.

The controller 70 controls the substrate shifting mechanism 30 to draw up the substrates W having experienced the cleaning process above the inner tank 40 where the controller 70 controls the dry-air generator 60 to supply dry air DF to the substrates W that are being drawn up. As a result, the pure water adhered to the substrates W is replaced by the dry air DF, so that surfaces of the substrates W are dried (drying process).

At times other than the drying process, the controller 70 controls the dry-air generator 60, thereby reducing the supply amount of the dry air DF into the downflow duct 20 (slow leak).

At the time of drawing up the substrates W from the inner tank 40 (during drying processing), the controller 70 controls the processing liquid mixer 50 to continuously supply a small amount of water into the inner tank 40. At this time, the controller 70 controls the shutter driver 40D to open the plurality of through-holes 40h disposed in an upper part of the inner tank 40. Thus during a drying process of the substrates W, pure water flow out through the plurality of through-holes 40h provided in the upper part of the inner tank 40. The pure water flowing out through the through-holes 40h is exhausted from the processing liquid exhausting tube 44 via the outer tank 43. Details will be described later.

Each of the processing liquid supplying tube 41 and the processing liquid exhausting tubes 42, 44 has a valve (not illustrated). The controller 70 also controls opening/closing operations of these valves. In this way, opening/closing operations of the supplying and exhausting systems of the processing liquid in the processing tank 4 are controlled by the controller 70.

(3-b) Details of Structure of Substrate Processing Apparatus

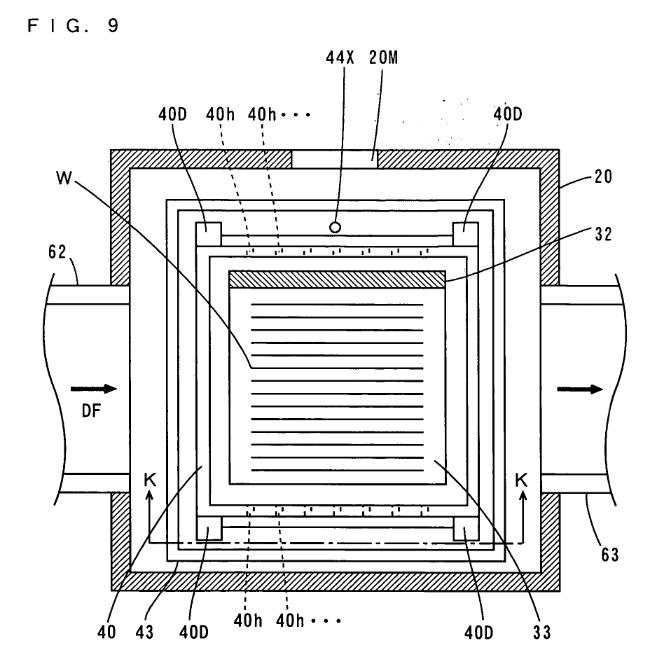

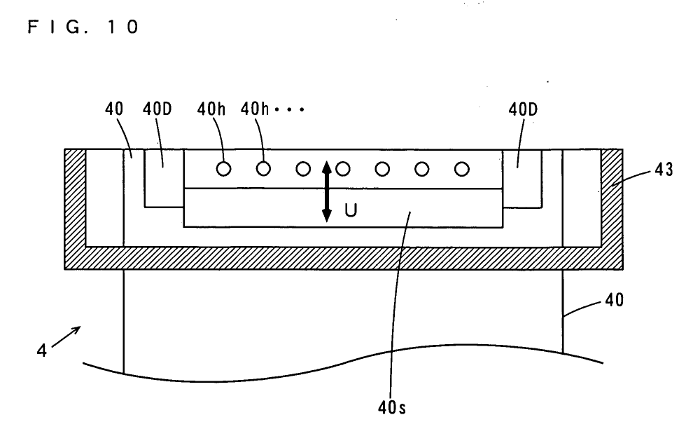

FIG. 9 is a schematic cross section view of the substrate processing apparatus 100 along the line J-J in FIG. 8; and FIG. 10 is a schematic cross section view of the substrate processing apparatus 100 along the line K-K in FIG. 9. FIGS. 9 and 10 illustrate the state that the holder 33 holding the plurality of substrates W is placed within the inner tank 40 by the substrate shifting mechanism 30.

As shown in FIGS. 9 and 10, in an upper part of the lateral wall of the inner tank 40, a plurality of through-holes 40h are formed in line along the horizontal direction. As described above, the plurality of thorough-holes 40h allow communication between the interior space of the inner tank 40 and the interior space of the outer tank 43.

On both lateral sides in the horizontal direction of the plurality of through-holes 40h, the shutter driver 40D is attached. The liquid level adjusting shutter 40s is made from a longitudinal plate, and held by the shutter driver 40D in a vertically movable manner while its longitudinal direction is orientated in the horizontal direction.

Under the control by the controller 70, the shutter driver 40D vertically (in the direction denoted by the arrow U in FIG. 10) shifts the liquid level adjusting shutter 40s. In this manner, the plurality of through-holes 40h formed in the inner tank 40 are opened/closed.

(3-c) Operation and Function of Liquid Level Adjusting Shutter

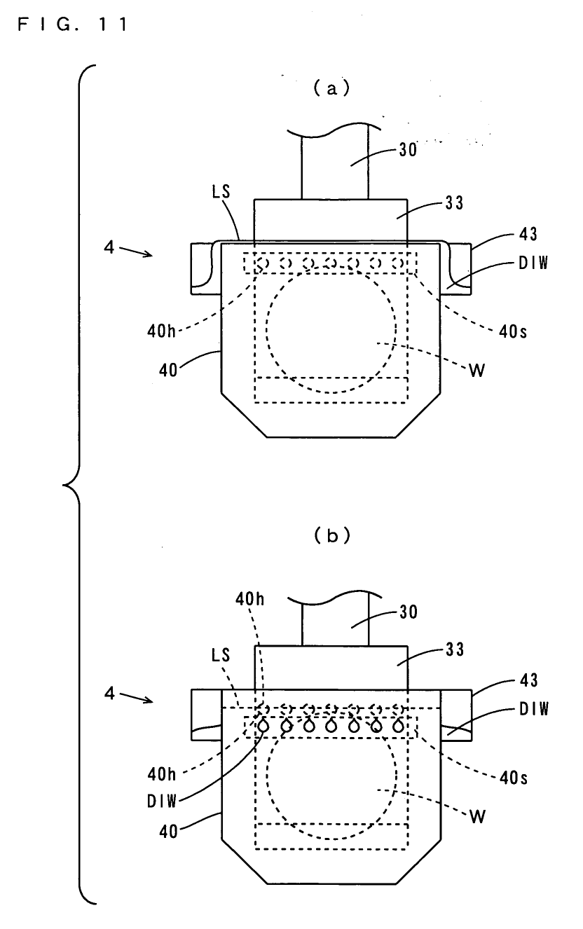

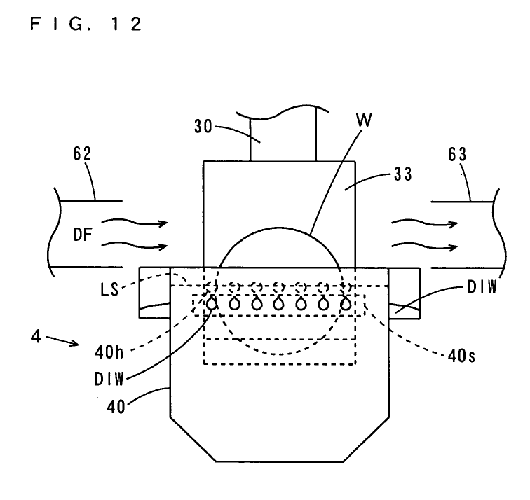

FIGS. 11 and 12 are views for illustrating the operation and function of the liquid level adjusting shutter 40s during a cleaning process and a drying process in the substrate processing apparatus 100 according to the third embodiment.

FIG. 11(a) shows a position of the liquid level adjusting shutter 40s and a condition of the liquid level LS of the pure water supplied to the inner tank 40 in a drying process of the substrates W.

During a cleaning process of the substrates W, the plurality of substrates W held, for example, by the holder 33 are dipped into the pure water DIW within the inner tank 40 by the substrate shifting mechanism 30. In this cleaning process, great volume of the pure water DIW is supplied into the inner tank 40 from the processing liquid supplying tube 41 (FIG. 8). In this state, the shutter driver 40D holds the liquid level adjusting shutter 40s such that it blocks the plurality of through-holes 40h.

As a result, during the cleaning process of the substrates W, the pure water DIW overflows from the upper end of the inner tank 40 and flows into the outer tank 43. The pure water DIW flowing into the outer tank 43 is then exhausted through the processing liquid exhausting tube 44 shown in FIG. 8. In this case, the liquid level LS of the pure water DIW comes into substantially flush with the upper end of the inner tank 40.

FIG. 11(b) shows a position of the liquid level adjusting shutter 40s and a condition of the liquid level LS of the pure water supplied to the inner tank 40 at the end of the drying process of the substrates W.

Also at the end of the cleaning process of the substrates W, a small amount of pure water DIW is supplied into the inner tank 40 through the processing liquid supplying tube 41 (FIG. 8). In this state, the shutter driver 40D shifts the liquid level adjusting shutter 40s to let open the plurality of through-holes 40h be open.

As a result, in a cleaning process of the substrates W, the pure water DIW in the inner tank 40 flows into the outer tank 43 through the plurality of through-holes 40h. The pure water DIW flowing into the outer tank 43 is then exhausted through the processing liquid exhausting tube 44 shown in FIG. 8. In this case, the liquid level LS of the pure water DIW descends from the upper end of the inner tank 40 and disposed at a vertical position where the plurality of through-holes 40h are formed.

In this state, as shown in FIG. 12, the plurality of substrates W held by the holder 33 are drawn up from the inner tank 40 by the substrate shifting mechanism 30. In this state, the dry air DF is blown from the dry-air supplying duct 62 to a region of the substrates W that is gradually coming into exposure from the pure water DIW. This achieves the aforementioned drying process.

Also in a drying process, a small amount of pure water DIW is supplied from the processing liquid supplying tube 41 (FIG. 8) into the inner tank 40 where the shutter driver 40D holds the liquid level adjusting shutter 40s with the plurality through-holes 40h being open. Accordingly, during the drying process, the liquid level LS of the pure water DIW is disposed at a vertical level at which the plurality of through-holes 40h are formed.

In this case, the liquid level LS of the pure water DIW is not disposed at the upper end of the inner tank 40. Therefore, the gas flow of the dry air DF flowing from the dry-air supplying duct 62 to the dry-air exhaust duct 63 is prevented from directly coming into contact with the pure ware DIW at the upper end of the inner tank 40.

Consequently, it is possible to prevent occurrence of turbulence caused by the gas flow of the dry air DF at the liquid level LS of the pure water DIW. As a result, inadequate drying of the substrate W is prevented. Driving of the liquid level adjusting shutter 40s by the shutter driver 40D is controlled by the controller 70.

In the present embodiment, the drying process is performed by supplying the substrates W with the dry air DF. The gas supplied to the substrates W is not limited to the dry air DF. Instead of the dry air DF, IPA (isopropyl alcohol) vapor, or low-temperature N₂ (nitrogen) gas may be used, for example.

(4) Correspondence Between Constituents in Claims and Elements in Embodiments

In the following paragraphs, non-limiting examples of correspondences between various elements recited in the claims below and those described above with respect to various preferred embodiments of the present invention are explained.

In the first and the second embodiments, the processing tank 4 and the inner tank 40 correspond to a processing tank, and the substrate shifting mechanism 30 and the controller 70 correspond to a substrate moving up/down device, the dry air DF corresponds to a gas, the dry-air generator 60, the piping 61, the dry-air supplying duct 62, the dry-air exhaust duct 63 and the controller 70 correspond to a gas supplying device.

The dry-air supplying duct 62 corresponds to a gas supplying duct and a lateral gas supplying duct, the piping 61 corresponds to a gas supplying system, the space where the ventilation guide 62a is not provided in the dry-air supplying duct 62 correspond to a flow-in space, and the dry-air injecting opening 62k corresponds to a gas flow outlet.

Further, the partition plate 62b corresponds to a blocking part and a blocking member, the partition plate 62c corresponds to a shielding part, the dry-air supplying duct 64 corresponds to an upper gas supplying duct, and the dry-air exhaust duct 63 corresponds to an exhaust duct.

The dry air DF corresponds to a gas, and the rinsing solution and the pure water correspond to a processing liquid.

In the above third embodiment, the rinsing solution and the pure water correspond to a processing liquid, the processing tank 4 and the inner tank 40 correspond to a processing tank, the substrate shifting mechanism 30 and the controller 70 correspond to a substrate moving up/down device, the plurality of through-holes 40h, the liquid level adjusting shutter 40s, the shutter driver 40D and the controller 70 correspond to a liquid level lowering device.

The dry air corresponds to a gas, the dry-air generator 60, the piping 61, the dry air supplying duct 62 and the controller 70 correspond to a gas supplying device.

Further, the plurality of through-holes 40h correspond to an opening, the liquid level adjusting shutter 40s, the shutter driver 40D and the controller 70 correspond to an opening/closing device.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A substrate processing apparatus for performing a predetermined process on a substrate, comprising:
a processing tank that stores a processing liquid;
a substrate moving up/down device that moves up/down a substrate between a position in the processing liquid stored in said processing tank and a position above said processing tank; and
a gas supplying device that supplies gas to a substrate that is being drawn up from said processing tank by said substrate moving up/down device,
said gas supplying device including
a gas supplying duct disposed on one lateral side of said processing tank, for supplying gas from said one lateral side to the other lateral side of said processing tank along an upper end of said processing tank and
a gas supplying system that supplies gas to said gas supplying duct,
said gas supplying duct having a flow-in space into which the gas supplied from said gas supplying system is fed, and a gas flow outlet extending substantially horizontally, for flowing out the gas toward said processing tank,
said gas flow outlet being provided such that a cross section of gas flow from said gas supplying duct to said processing tank is smaller than an area from an upper end of said flow-in space to a lower end of said flow-in space in a vertical direction.

2. The substrate processing apparatus according to claim 1, wherein said gas flow outlet is provided such that a cross section of a gas flow from said gas supplying duct to said processing tank is limited within a region extending from a position lower than an upper end of said flow-in space to a lower end of said flow-in space.

3. The substrate processing apparatus according to claim 2, wherein said gas flow outlet is formed by providing a blocking part that blocks a region extending from a position lower than an upper end to the upper end of said gas supplying duct on the side of said processing tank.

4. The substrate processing apparatus according to claim 3, wherein said blocking part has a blocking member provided in an end of said gas supplying duct so as to be movable up and down.

5. The substrate processing apparatus according to claim 2, wherein said gas flow outlet is formed in said flow-in space by providing a shielding part that shields a region extending from a position lower than an upper end to the upper end of said flow-in space.

6. The substrate processing apparatus according to claim 5, wherein said shielding part is inclined so that its lower end is closer to said processing tank than its upper end.

7. The substrate processing apparatus according to claim 1, wherein said gas flow outlet is formed such that a height from an upper end of said processing tank to an upper end of said gas flow outlet in an end of said gas supplying duct is more than 0 cm and not more than 5 cm.

8. The substrate processing apparatus according to claim 1, wherein in the direction orthogonal to the direction in which gas flows on a horizontal plane, a width of said gas flow outlet is more than or equal to a width of said processing tank.

9. The substrate processing apparatus according to claim 1, wherein said gas supplying device further includes
an exhaust duct disposed on said other lateral side of said processing tank, for exhausting an atmosphere above said processing tank.

10. The substrate processing apparatus according to claim 1, wherein said gas is dry air.

11. The substrate processing apparatus according to claim 1, wherein said processing liquid is pure water.

12. A substrate processing apparatus for performing a predetermined process on a substrate, comprising:
a processing tank that stores a processing liquid;
a substrate moving up/down device that moves up/down a substrate between a position in the processing liquid stored in said processing tank and a position above said processing tank; and
a gas supplying device that supplies gas to a substrate that is being drawn up from said processing tank by said substrate moving up/down device,
said gas supplying device including
a lateral gas supplying duct disposed on one lateral side of said processing tank, for supplying gas from said one lateral side to the other lateral side of said processing tank along an upper end of said processing tank, and
an upper gas supplying duct disposed above said processing tank, for supplying gas from above toward below of said processing tank.

13. The substrate processing apparatus according to claim 12, wherein said gas supplying device further includes
an exhaust duct disposed on said other lateral side of said processing tank, for exhausting an atmosphere above said processing tank.

14. The substrate processing apparatus according to claim 12, wherein said gas is dry air.

15. The substrate processing apparatus according to claim 12, wherein said processing liquid is pure water.

16. A substrate processing apparatus for performing a predetermined process on a substrate, comprising:
a processing tank that stores a processing liquid;
a substrate moving up/down device that moves up/down a substrate between a position in said processing liquid in said processing tank and a position above said processing tank;
a gas supplying device that supplies gas from one lateral side to the other lateral side of said processing tank along an upper end of said processing tank to supply gas to the substrate that is being drawn up from said processing tank by said substrate moving up/down device; and
a liquid level lowering device that lowers a liquid level of processing liquid stored in said processing tank to below an upper end of said processing tank while gas is supplied to the substrate by said gas supplying device.

17. The substrate processing apparatus according to claim 16, wherein an opening is formed at a position lower than an upper end of a lateral wall of said processing tank, and said liquid surface lowering device has an opening/closing device capable of opening or closing said opening.

18. The substrate processing apparatus according to claim 17, wherein said opening comprises a plurality of through-holes formed to be in line in a horizontal direction.

19. The substrate processing apparatus according to claim 16, wherein said gas is dry air.

20. The substrate processing apparatus according to claim 16, wherein said processing liquid is pure water.
